(19) United States
(12) Patent Application Publication
(10) Pub. No.: US 2016/0141820 A1
(43) Pub. Date: May 19, 2016

(54) COAXIAL COMPRESSION TOOL WITH COAXIAL CABLE GRIP

(71) Applicant: Anthony Williams, Spartanburg, SC (US)

(72) Inventor: Anthony Williams, Spartanburg, SC (US)

(21) Appl. No.: 14/940,605

(22) Filed: Nov. 13, 2015

Related U.S. Application Data
(60) Provisional application No. 62/079,002, filed on Nov. 13, 2014.

(51) Int. Cl. H01R 43/042

(52) U.S. Cl. CPC H01R 43/042

(57) ABSTRACT

A handheld coaxial cable compression tool includes a tool body, a lever arm pivotally connected at one end to the tool body and a drive pin coupled to the lever arm via at least one mechanical linkage where a force applied to the lever arm causes the drive pin to translate along a longitudinal axis of the tool. The handheld coaxial cable compression tool also includes a cable grip that is longitudinally spaced from the drive pin. The cable grip includes a mast portion that extends outwardly from the tool body, a lower grip arm and an upper grip arm. The lower grip arm and the upper grip arm prevent longitudinal movement of a coaxial cable held therebetween when a longitudinal force is applied to the coaxial cable via the drive pin.

### RELATED APPLICATIONS

The present application is based on and claims priority to U.S. Provisional Patent application Ser. No. 62/079,002, filed on Nov. 13, 2014, which is incorporated herein by reference.

### FIELD OF THE INVENTION

The present invention generally involves a coaxial compression tool for compressing a connector onto a coaxial cable. More specifically, the invention relates to a compression tool having a cable grip for retaining a coaxial to the tool during operation thereof.

### BACKGROUND OF THE INVENTION

Installers are required to make new and/or custom length coaxial cables in the field. More specifically, installers must compress compression type connectors to a pre-prepped end of the coaxial cable. In a typical day and/or week, an installer must assemble a large number of coaxial cables, Various tools are known and available in the industry for compressing the coaxial connectors to the coaxial cables.

One primary issue for installers is that a remainder of the coaxial cable hangs loose from the coaxial compression tool thus causing the installer to fumble with the excess cable while trying to fit the prepped end into a carrier portion of the tool and/or while trying to pre-load a compression connector into the tool. As a result, the coaxial cable may slip from the tool and/or may not properly align with the compression connector, thus resulting in a defective cable. This can be particularly troublesome while working in cold weather with or without gloves, in confined spaces and/or after assembling multiple cables. Therefore, there exists a need for an improved coaxial compression tool for compressing a connector onto a coaxial cable particularly one that includes a cable grip or system for holding or retaining the coaxial cable.

### BRIEF DESCRIPTION OF THE INVENTION

Aspects and advantages of the invention are set forth below in the following description, or may be obvious from the description, or may be learned through practice of the invention.

One embodiment of the present invention is directed to a handheld coaxial cable compression tool includes a tool body, a lever arm that is pivotally connected at one end to the tool body and a drive pin that is coupled to the lever arm via at least one mechanical linkage such that a force applied to the lever arm causes the drive pin to translate along a longitudinal axis of the tool. The handheld coaxial cable compression tool further includes a cable grip that is longitudinally spaced from the drive pin. The cable grip includes a mast portion that extends outwardly from the tool body, a lower grip arm and an upper grip arm. The lower grip arm and the upper grip arm prevent longitudinal movement of a coaxial cable held therebetween when a longitudinal force is applied to the coaxial cable via the drive pin.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a side view of an exemplary coaxial compression tool including a cable grip according to at least one embodiment of the present invention;

FIG. 2 is an aft view of the coaxial compression tool including the cable grip as shown in FIG. 1, according to at least one embodiment of the present invention;

FIG. 3a is a bottom view of an upper grip arm portion of the cable grip according to one or more embodiments of the present invention;

FIG. 3b is an aft view of the upper grip arm portion of the cable grip as shown in FIG. 3a, according to one or more embodiments of the present invention;

FIG. 4a is a top view of a lower grip arm portion of the cable grip according to one or more embodiments of the present invention;

FIG. 4b is an aft view the lower grip arm portion of the cable grip as shown in FIG. 4a, according to one or more embodiments of the present invention;

FIG. 5 is a cross sectional aft view of the cable grip and a portion of the coaxial compression tool as shown in FIG. 1, according to one embodiment of the present invention;

FIG. 6 is a cross sectional aft view of the cable grip and a portion of the coaxial compression tool as shown in FIG. 1, according to one embodiment of the present invention;

FIG. 7 is a cross sectional aft view of the cable grip and a portion of the coaxial compression tool as shown in FIG. 1, according to one embodiment of the present invention; and

FIG. 8 is a cross sectional aft view of the cable grip and a portion of the coaxial compression tool as shown in FIG. 1, according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

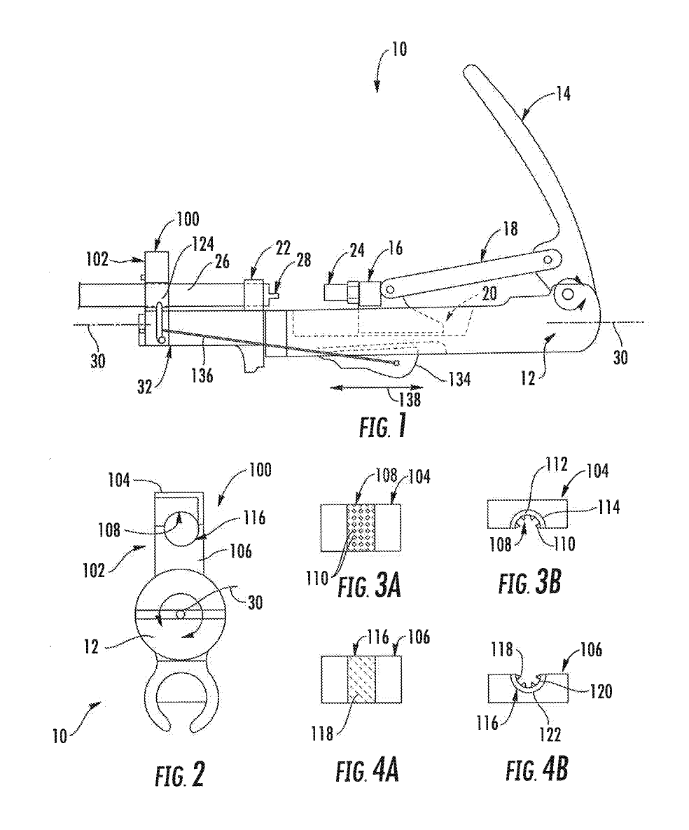

Referring now to the drawings, wherein identical numerals indicate the same elements throughout the figures, FIG. 1 provides a side view of an embodiment of a coaxial compression tool 10 or “tool” as may incorporate one or more embodiments of the present invention. As shown in FIG. 1, the tool 10 may include a tool body 12 and a lever arm 14. The lever arm 14 may be pivotally connected at one end to the tool body 12. A plunger or drive pin 16 may be coupled to the lever arm 14 via at least one mechanical linkage 18. The drive pin 16 may be slideably engaged with the tool body 12. For example, the drive pin 16 may be slideably mounted in a groove or slot 20 defined within the tool body 12.

In particular configurations, the tool 10 may include a connector bracket 22 longitudinally spaced from the drive pin 16. The connector bracket 22 may be coupled or connected to or formed as an integral part of the tool body 12. The connector bracket 22 may be formed to hold and/or support a coaxial compression connector 24 and/or at least. a portion of a coaxial cable 26 in position during operation of the tool 10. For example, when a downward force is applied to the lever arm 14 the drive pin 16 and the coaxial compression connector 24 translate longitudinally with respect to a longitudinal axis 30 of the tool 10 towards the connector bracket 22 and/or a prepped end 28 of the coaxial cable 26.

In various embodiments, the tool 10 includes a cable grip 100 for holding and/or positioning the coaxial cable 26 prior to and/or during operation of the tool 10. As shown in FIG. 1, the cable grip 100 is separated longitudinally from the connector bracket 22 and/or the drive pin 16 with respect to the longitudinal axis 30 of the tool. 10. FIG. 2 provides an aft view of the tool 10 including the cable grip 100. As shown in FIG. 2, the cable grip 100 includes a mast portion 102, a top or upper grip arm 104 and a bottom or lower grip arm 106. The mast portion 102 may extend outwardly from the tool body 12 at least partially perpendicular to the longitudinal axis 30 of the tool 10. For example, as shown in FIG. 2, the mast portion 102 may extend upwardly from the tool body 12. In one embodiment, as shown in FIG. 2, the cable grip portion 100 is mounted to an aft end 32 (FIG. 1) of the tool body 12 and is rotatable about the longitudinal axis 30 of the tool 10.

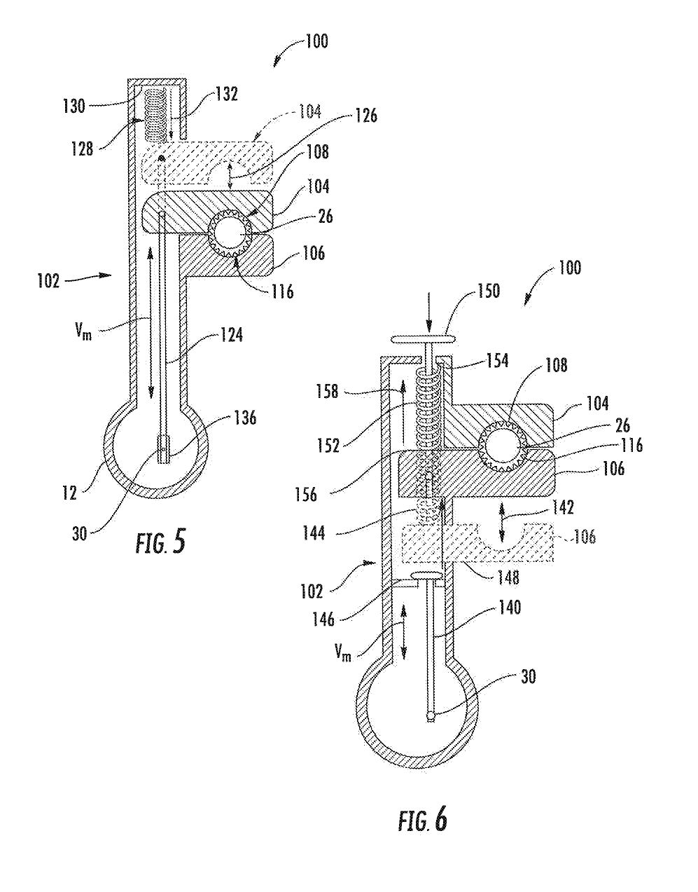

FIG. 3a provides a bottom view of the upper grip aim 104 according to at least one embodiment. FIG. 3b provides an aft view of the upper grip arm 104 according to at least one embodiment. In various embodiments, as shown in FIGS. 2, 3a and 3b, the upper grip arm 104 includes a cradle portion 108. The cradle portion 108 may have any shape that is suitable for receiving the coaxial cable 26. For example, as shown, the cradle portion 108 may be at least partially arcuate or semi-hemispherical. In other configurations, the cradle portion 108 may be rectangular, square, triangular, etc. The particular shape of the cradle portion 108 is not limited to any particular shape unless otherwise recited in the claims.

In particular embodiments, as shown in FIGS. 3a and 3b, a plurality of surface or friction features 110 may be disposed or formed along or within the cradle portion 108. The surface features 110 may include ribs, spikes or similar surface features that enhance gripping function of the upper grip arm 104. The surface features 110 may be formed (i.e. machined or cast) in the cradle portion 108, or as shown in FIG. 3b, the surface features 110 may be provided as an insert or tape 112 fixedly connected to a surface 114 of the cradle portion 108.

FIG. 4a provides a bottom view of the lower grip arm 106 according to at least one embodiment. FIG. 4b provides an aft view of the lower grip arm 106 according to at least one embodiment. In various embodiments, as shown in FIGS. 2, 4a and 4b, the lower grip arm 106 includes a cradle portion 116. The cradle portion 116 may have any shape that is suitable for receiving the coaxial cable 26. For example, as shown, the cradle portion 116 may be at least partially arcuate or semi-hemispherical and/or may be complementary to cradle portion 108 of the upper grip arm 104. In other configurations, the cradle portion 116 may be rectangular, square, triangular, etc. The particular shape of the cradle portion 116 is not limited to any particular shape unless otherwise recited in the claims.

In particular embodiments, as shown in FIGS. 4a and 4b, a plurality of surface or friction features 118 may be disposed or formed along or within the cradle portion 116. The surface features 118 may include ribs, spikes or similar surface features that enhance gripping function of the lower grip arm 106. The surface features 118 may be formed (i.e. machined or cast) in the cradle portion 116, or as shown in FIG. 4b, the surface features 118 may be provided as an insert or tape 120 fixedly connected to a surface 122 of the cradle portion 116.

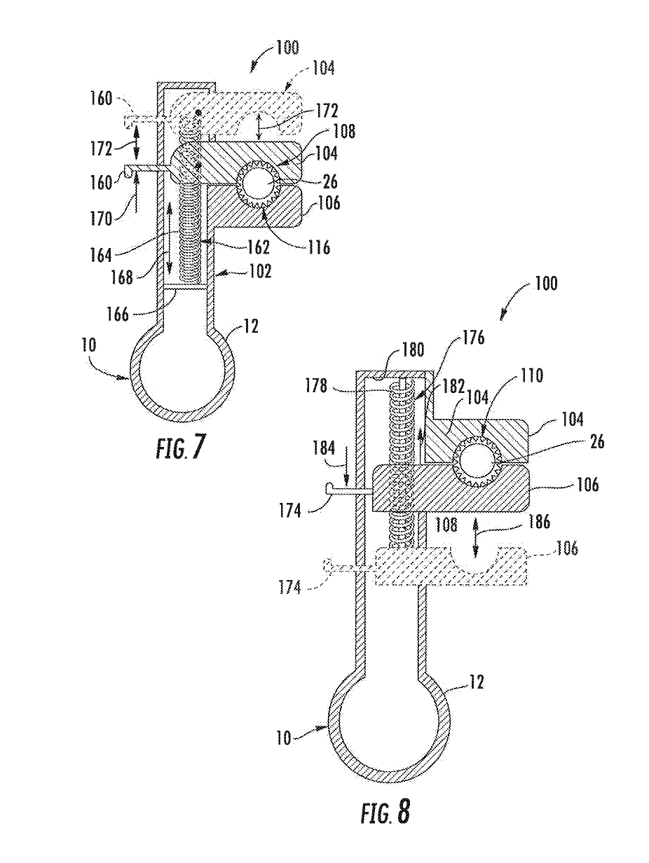

FIGS. 5, 6, 7 and 8 provide cross sectional aft views of the cable grip 100 and a portion of the tool body 12 according to various embodiments of the present invention. In one embodiment, as shown in FIG. 5, as shown in FIG. 5, the upper grip arm 104 may be slideably mounted or seated within the mast portion 102. The upper arm 104 is mechanically coupled to at least one mechanical linkage 124. The mechanical linkage 124 may extend at least partially within the mast portion 102. The mechanical linkage 124 is configured such that manipulation thereof will result in vertical movement Vₘ of the upper grip arm 104. For example, as shown in dotted. lines in FIG. 5, in one embodiment manipulation of the mechanical linkage 124 may cause the upper grip arm 104 to rise with respect to the lower grip arm 106 a sufficient vertical distance 126 to allow for insertion of the coaxial cable 26.

In one embodiment, a spring or spring member 128 may be disposed within the mast portion 102 between an inner surface 130 or other feature defined within the mast portion 102, and the upper grip arm 104. The spring member 128 may include any type of spring or other member or device that provides a downward or compressive force 132 suitable to maintain the upper grip arm 104 in a closed position as shown in solid, lines with relation to the lower grip arm 106. For example, the spring member 128 may comprise a helical spring, spring washer, leaf spring or the like. The compressive force 132 is generally suitable to hold the coaxial cable 26 between the cradle portions 108, 116 of the upper grip arm 104 and the lower grip arm 106, thus freeing the hands of the technician to operate the tool 10.

In various embodiments, as shown in FIG. 1, the mechanical linkage 124 is mechanically coupled to an actuator or handle 134 via one or more mechanical linkages 136 such as arms, pins and/or springs. In one embodiment, as shown in FIG. 1, the handle 134 is slideably coupled to the tool body 12, thus allowing for generally longitudinal movement 138 with respect to the longitudinal axis 30. In one embodiment, manipulation of the handle 134, such as in the longitudinal direction 138, causes the mechanical linkage 124 (FIG. 5) to raise and/or lower the upper grip arm 104, thus allowing for insertion and removal of the coaxial cable 26 as desired.

In one embodiment, as shown in FIG. 6, the lower grip arm 106 may be slideably mounted or seated within the mast portion 102. The lower grip arm 106 is mechanically coupled to at least one mechanical linkage 140. The mechanical linkage 140 may extend at least partially within the mast portion 102. The mechanical linkage 140 is configured such that manipulation thereof will result in vertical movement Vₘ of the lower grip arm 106 with respect to longitudinal axis 30. For example, as shown in dotted lines in FIG. 6, manipulation of the mechanical linkage 140 may cause the lower grip arm 106 to fall with respect to the upper grip arm 104 a sufficient vertical distance 142 to allow for insertion of the coaxial cable 26.

In one embodiment, a spring or spring member 144 may be disposed within the mast portion 102 between an inner surface 146 or other support feature defined within the mast portion 102 and the lower grip arm 106. The spring member 144 may include any type of spring or other member or device that provides an upward or compressive force 148 suitable to maintain the lower grip arm 106 in an at least partially of fully closed position as shown in solid lines with relation to the upper grip arm 104. For example, the spring member 144 may comprise a helical spring, spring washer, leaf spring or the like. The compressive force 148 is generally suitable to hold the coaxial cable 26 between the cradle portions 108, 116 of the upper grip arm 104 and the lower grip arm 106, thus freeing the hands of the technician to operate the tool 10.

In various embodiments, as shown in FIG. 1, the mechanical linkage 140 is mechanically coupled to the actuator or handle 134 via the one or more mechanical linkages 136. In one embodiment, manipulation of the handle 134, such as in the longitudinal direction 138, causes the mechanical linkage 140 (FIG. 5) to lower and/or rise the lower grip arm 106, thus allowing for insertion and removal of the coaxial cable 26 as desired.

In one embodiment, as shown in FIG. 6, the lower grip arm 106 may he vertically manipulated (raised or lowered) via a plunger 150. The plunger 150 may extend through the mast portion 102 and engage with the lower grip arm 106. A tension spring 152 may be connected at one end of the spring to a seating surface 154 within the mast portion 102 and to a top portion 156 of the lower grip arm 106. The tension spring 152 generally provides a tension force 158 that is sufficient to hold the coaxial cable 26 between the cradle portions 108, 116 of the upper grip arm 104 and the lower grip arm 106, thus freeing the hands of the technician to operate the tool 10.

In one embodiment, as shown in FIG. 7, the upper grip arm 104 is slideably mounted or seated within the mast portion 102. In this embodiment, a tab member 160 extends through an opposing side of the mast portion 102. A spring member 162 may be coupled to the upper grip arm within the mast portion 102. For example, a tension spring member 164 may be coupled to a lower seating surface 166, thereby providing a tension or downward force 168 to the upper grip arm 104. The tension force 168 may be generally suitable to hold the coaxial cable 26 between the cradle portions 108, 116 of the upper grip arm 104 and the lower grip arm 106, thus freeing the hands of the technician to operate the tool 10. A technician may apply a at least partially upward force 170 on the tab member 160, for example via their thumb or finger, thus raising the upper grip arm 104 a sufficient vertical distance 172 so as to insert and/or release the coaxial cable 26.

In an alternate embodiment, as shown in FIG. 8, the lower grip arm 106 is slideably mounted or seated within the mast portion 102. In this embodiment, a tab member 174 extends through an opposing side of the mast portion 102. A spring member 176 may be coupled to the lower grip arm 106 within the mast portion 102. For example, a tension spring member 178 may be coupled to a seating surface 180 of the mast portion 102, thereby providing a tension or upward force 182 to the lower grip arm 106. The tension force 182 may be generally suitable to hold the coaxial cable 26 between the cradle portions 108, 116 of the upper grip arm 104 and the lower grip arm 106, thus freeing the hands of the technician to operate the tool 10. A technician may apply a downward force 184 on the tab member 174, for example via their thumb or finger, thus lower the lower grip arm 106 a sufficient vertical distance 186 to insert and/or release the coaxial cable 26.

This written description uses examples to disclose the invention, including the best mode and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the

What is claimed is:

1. A handheld coaxial compression tool, comprising:
a tool body;
a lever arm pivotally connected at one end to the tool body;
a drive pin coupled to the lever arm via at least one mechanical linkage, wherein a force applied to the lever arm causes the drive pin to translate along a longitudinal axis of the tool; and
a cable grip longitudinally spaced from the drive pin, the cable grip having a mast portion extending outwardly from the tool body, a lower grip arm and an upper grip arm, wherein the lower grip arm and the upper grip arm prevent longitudinal movement of a coaxial cable held therebetween when a longitudinal force is applied to the coaxial cable via the drive pin.

2. The handheld coaxial cable compression tool as in claim 1, further comprising a connector bracket longitudinally spaced between the drive pin and the cable grip.

3. The handheld coaxial cable compression tool as in claim 1, wherein the upper grip arm includes a cradle portion for receiving the coaxial cable.

4. The handheld coaxial cable compression tool as in claim 3, wherein the cradle portion of the upper grip arm includes a plurality of friction features disposed along an inner surface of the cradle portion.

5. The handheld coaxial cable compression tool as in claim 1, wherein the lower grip arm includes a cradle portion for receiving the coaxial cable.

6. The handheld coaxial cable compression tool as in claim 5, wherein the cradle portion of the lower grip arm includes a plurality of friction features disposed along an inner surface of the cradle portion.

7. The handheld coaxial cable compression tool as in claim 1, wherein the cable grip includes a spring member that is coupled to at least one of the lower grip arm and the upper grip arm and exerts opposing compressive forces on the lower arm and the upper arm.

8. The handheld coaxial cable compression tool as in claim 7, wherein the spring member is one of a helical spring, spring washer or a leaf spring.

9. The handheld coaxial cable compression tool as in claim 1, Wherein the upper grip arm is slideably mounted within the mast portion and mechanically coupled to at least one mechanical linkage, wherein manipulation of the mechanical linkage results in vertical movement of the upper grip arm.

10. The handheld coaxial cable compression tool as in claim 1, wherein the lower grip arm is slideably mounted within the mast portion and mechanically coupled to at least one mechanical linkage, wherein manipulation of the mechanical linkage results in vertical movement of the lower grip arm.

11. The handheld coaxial cable compression tool as in claim 1, further comprising a handle slideably coupled to the tool body, wherein longitudinal manipulation of the handle raises the upper grip arm to allow for insertion and removal of the coaxial cable.

12. The handheld coaxial cable compression tool as in claim 1, further comprising a handle slideably coupled to the tool body, wherein longitudinal manipulation of the handle lowers the lower grip arm to allow for insertion and removal of the coaxial cable.

13. The handheld coaxial cable compression tool as in claim 1, further comprising a plunger extending through the mast portion and engaged with the lower grip arm, wherein a downward force applied to an end portion of the plunger moves the lower grip arm vertically away from the upper grip arm.

14. The handheld coaxial cable compression tool as in claim 1, further comprising a spring member connected at a first end to a seating surface defined within the mast portion and connected at a second end to a top portion of the lower grip arm, wherein the spring member exerts a tension force on the lower grip arm to hold the coaxial cable between the upper grip arm and the lower grip arm.

15. The handheld coaxial cable compression tool as in claim 1, wherein the upper grip arm is slideably mounted within the mast portion, wherein the upper grip area includes a tab member extending outwardly from the mast portion, wherein a first end of a spring member is coupled to a lower seating surface within the mast portion and a second end of the spring member is connected to the upper grip arm.

16. The handheld coaxial cable compression tool as in claim 1, wherein the lower grip arm is slideably mounted within the mast portion, Wherein the lower grip arm includes a tab member extending outwardly from the mast portion, wherein a first end of a spring member is coupled to an upper seating surface within the mast portion and a second end of the spring member is connected to the lower grip arm.

17. The handheld coaxial cable compression tool as in claim 1, wherein the cable grip is mounted to an aft end of the tool body and is rotatable about the longitudinal axis of the tool.
